(19) United States
(12) Patent Application Publication
(10) Pub. No.: US 2007/0094519 A1
(43) Pub. Date: Apr. 26, 2007

(54) Electronic device and electronic device control method

(76) Inventor: Hiroshi Yamamoto, Tokyo (JP)

Correspondence Address: KATTEN MUCHIN ROSENMAN LLP, 575 MADISON AVENUE, NEW YORK, NY, 10022-2585, US

(21) Appl. No.: 10/576,985

(22) PCT Filed: Oct. 21, 2004
(86) PCT No.: PCT/JP04/15616

§ 371 Date: Oct. 19, 2006

(30) Foreign Application Priority Data
Oct. 21, 2003 (JP) JP03/13446

(51) Int. Cl. G06F 1/00

(52) U.S. Cl. 713/300

(57) ABSTRACT

A monitoring unit detects a remaining level of a battery. When the battery level falls below a predetermined threshold, an electronic apparatus enters a power saving mode. In the power saving mode, the processing load of a control unit, or a first main CPU and the like, is reduced. For that purpose, the level of spatial details or temporal detail in drawing is lowered. The load of audio processing or communication may also be lowered. Lowering the processing load can improve the battery life thereafter.

### BACKGROUND OF THE INVENTION

1. Field of the Invention

The present invention relates to an electronic apparatus, and more particularly to a battery-driven electronic apparatus.

2. Description of the Related Art

Portable electronic apparatuses capable of playing games and watching visual contents have been prevailing recently. Some of these electronic apparatuses have performance as high as favorably comparable with that of stationary apparatuses, so that users can enjoy a wide variety of games and other contents.

For such electronic apparatuses, battery life is a significant performance factor. Even if contents and other software products are available sufficiently, users are likely to become frustrated if battery life is limited.

### SUMMARY OF THE INVENTION

It is thus an intention of the present invention to provide an electronic apparatus which can extend battery life. While so-called power management technologies are conventionally known, the present invention provides an electronic apparatus that can exercise control more closely corresponding to the status of use by its user. For that purpose, the electronic apparatus of the present invention makes an adjustment to processing load in accordance with a remaining battery level.

One of the embodiments of the present invention relates to an electronic apparatus. This electronic apparatus is powered by a battery, comprising: a control unit which performs predetermined processing to execute a program; a monitoring unit which detects a remaining battery level; and an adjustment unit which adjusts processing load by changing a graphic processing performed in the control unit, in accordance with the remaining battery level detected by the monitoring unit.

Incidentally, any combinations of the foregoing components, and any conversions of expressions of the present invention from/into methods, apparatuses, systems, recording media, computer programs, and the like are also intended to constitute applicable aspects of the present invention.

### BRIEF DESCRIPTION OF THE DRAWINGS

The foregoing and other objects, features, and advantages of the present invention will become more apparent from the following description of a preferred embodiment when read in conjunction with the accompanying drawings, in which:

FIG. 1 is a general block diagram of an electronic apparatus according to an embodiment of the present invention;

FIG. 2 is a flowchart for showing a mode shift of the electronic apparatus according to the embodiment;

FIG. 3 is a flowchart for showing the steps by which a program according to the embodiment selects measures to execute when in a power saving mode; and

FIG. 4 is a diagram showing an example of a measure selection table according to the embodiment.

### DETAILED DESCRIPTION OF THE INVENTION

Now, suppose that a user is playing a game on an electronic apparatus. When the remaining level of the battery (hereinafter, referred to simply as “battery level”) is low, the user attempts to save the game status to suspend play. Nevertheless, many games have only certain “save points” at which data can be saved, and thus the battery level may run out before reaching a save point. To avoid this situation, it is desirable to reduce power consumption while continuing a game.

For this purpose, the electronic apparatus according to an embodiment reduces the processing load when the battery level is low. Specifically, the electronic apparatus comprises: a control unit which performs predetermined processing to execute a program; a monitoring unit which detects a battery level; and an adjustment unit which adjusts the processing load performed in the control unit in accordance with the battery level detected by the monitoring unit. In the cases where the operation of the adjustment unit is achieved by software means, the adjustment unit may be exemplified by a CPU itself, which may be the same component as the control unit.

According to this configuration, if the battery level is reduced to a low level, or if the battery level falls below a predetermined threshold, the processing load can be reduced to extend the battery life of the electronic apparatus thereafter. Processing load may be reduced by lowering the drawing and the audio processing, and in some cases, extends the battery life at the cost of a drop in the drawing quality or audio quality.

The adjustment unit may reduce the processing load by lowering the level of spatial or temporal details of the drawing processing. The adjustment unit may also reduce the audio processing load. When the control unit executes a game program, the adjustment unit may make adjustments so as to accelerate the progress of the game.

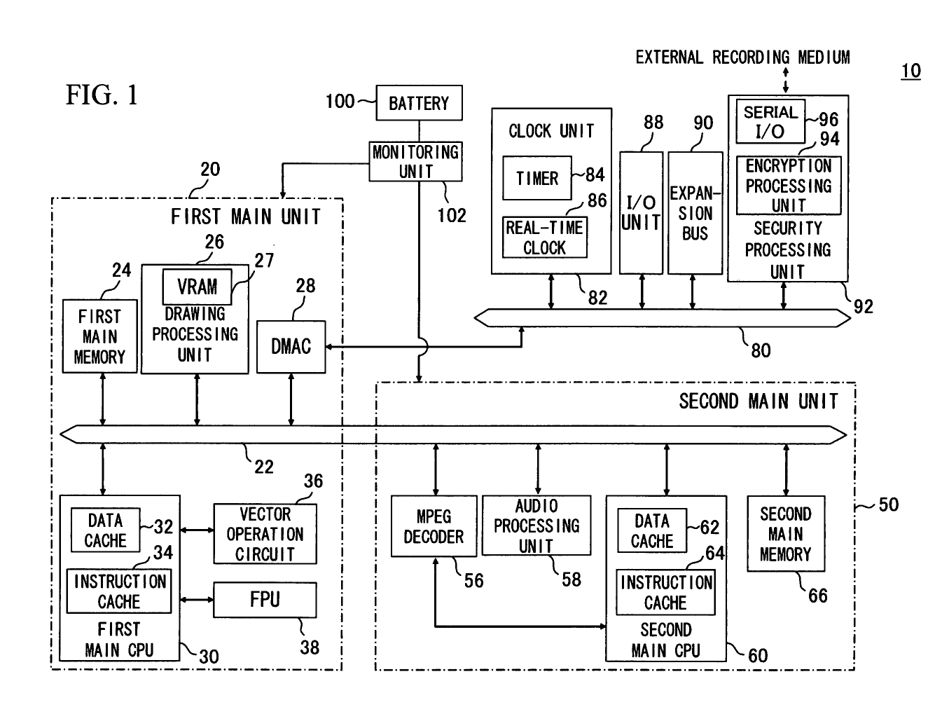

FIG. 1 shows the basic configuration of the electronic apparatus. The electronic apparatus 10 comprises a first main unit 20, a second main unit 50, an I/O bus 80, a clock unit 82, an I/O unit 88, an expansion bus 90, and a security processing unit 92.

The first main unit 20 exercises control over the entire electronic apparatus 10, and is the primary controller for drawing processing. This unit has a main bus 22, a first main memory 24, a drawing processing unit 26, a DMAC 28, a first main CPU 30, a vector operation circuit 36, and an FPU 38. The main bus 22 is connected with essential parts of the electronic apparatus 10, and transfers data between the individual parts at high speed. The first main memory 24 stores a game program and data necessary for executing the program. The program stored in the first main memory 24 is executed by the first main CPU 30. The first main CPU 30 includes a data cache 32 and an instruction cache 34.

Under instructions from the first main CPU 30, the vector operation circuit 36 processes geometric operations such as perspective transformation. The FPU 38 processes floating-point operations. The drawing processing unit 26 processes polygonal drawings and other shaped drawings based on drawing instructions received from the first main CPU 30. The drawing processing unit 26 includes a video memory or VRAM 27, as well as a display control circuit (not-shown). The display control circuit outputs displayable signals to a liquid crystal display unit (not-shown).

The DMAC 28 includes input and output ports connected with the main bus 22, and input and output ports connected with the I/O bus 80. The DMAC 24 transfers data between the main bus 22 and the I/O bus 80.

The second main unit 50 is the primary controller for multimedia processing. This unit has an MPEG decoder 56, an audio processing unit 58, a second main CPU 60, and a second main memory 66. The second main memory 66 stores programs generally different from the game programs described above, such as a program for reproducing a moving image, and data necessary for executing the programs. The programs stored in the second main memory 66 are executed by the second main CPU 60. The second main CPU 60 includes a data cache 62 and an instruction cache 64.

Under instructions from the second main CPU 60, the MPEG decoder 56 decodes image data that is coded in an MPEG format. The audio processing unit 58 decodes audio data that is coded in an MP3 or other format.

The I/O bus 80 transfers data between the DMAC 28 and the clock unit 82, the I/O unit 88, the expansion bus 90, or the security processing unit 92. The clock unit 82 includes a timer 84 for measuring time and a real-time clock 86 for keeping real time. The I/O unit 88 includes a plurality of general purpose I/O interfaces. The expansion bus 90 may also be used to add extra expansion devices.

The security processing unit 92 is connected with a drive which reads or writes data from/to an external recording medium such as an optical disk. The security processing unit 92 includes an encryption processing unit 94 and a serial I/O 96. The encryption processing unit 94 processes data encryption and decryption. The serial I/O 96 transfers data encrypted by the encryption processing unit 94 to the drive of the external recording medium, and transfers data from the external recording medium read by the drive to the encryption processing unit 94. Since all data read or written from/to the external recording medium is decrypted or encrypted by the hardware means at the time of reading or writing, it is possible to enhance the security of the data. Various types of I/O devices connected to the I/O bus 80 will hereinafter be described as being controlled by the second main CPU 60 when needed. It is understood, however, that those devices may also be controlled by the first main CPU 30.

A battery 100 supplies power to the entire electronic apparatus 10. A monitoring unit 102 monitors the remaining level of the battery 100 based on the voltage of the battery 100. The result of monitoring is communicated to the first main unit 20 and the second main unit 50. When the voltage of the battery 100 falls below a predetermined threshold, the electronic apparatus 10 enters a power saving mode. In the power saving mode, the processing load on the first main unit 20 and the second main unit 50, pertaining to the execution of the game and other programs, is reduced. Some aspects for reducing power load are listed below.

[1] Reduce the Load of the Drawing Processing

[1-1] Lower the Level of Spatial Detail Drawn.

This operation is achieved by the cooperation of the first main CPU 30, which receives an instruction to shift into the power saving mode (hereinafter, simply referred to as “shift instruction”) from the monitoring unit 102, and the drawing processing unit 26. The first main CPU 30 may be regarded as the foregoing control unit, and the drawing processing unit 26 as the foregoing adjustment unit. The combination of the two may be considered as a control and adjustment unit. The same concept applies throughout this specification. Also, it should be noted that, as a result of the cooperation of the first main CPU 30 and the drawing processing unit 26, the processing of the vector operation circuit 36 and the FPU 38 may sometimes be simplified or skipped. These effects are also derived from the power saving mode.

To lower the level of detail drawn, the game program implements, in advance, a module that runs in two modes, i.e., a normal mode and the power saving mode. The normal mode is a compatible mode that can work with other hardware. That is, when the program is run in hardware other than the electronic apparatus 10 according to the embodiment, where power saving is not a requirement, the module may operate in the normal mode alone. The electronic apparatus 10 starts up in the normal mode by default.

The first main CPU 30 receives a shift instruction through an interrupt waiting thread intended for shift instructions. This thread changes a mode flag, which the game program refers to in various scenes, from the “normal mode” to the “power saving mode.” After this instruction, the program subsequently operates in the power saving mode. During the power saving mode, the level of spatial detail drawn is lowered by the following measures. Note that the following measures depend on the way of classification, and can overlap with each other as actual techniques.

Lower LOD (Level Of Detail): LOD is a CG technique in which the level of detail in the models of respective objects is lowered in accordance with distances from a point of view. In the power saving mode, for example, all the distances between the respective objects and the point of view can be equally multiplied by a (a>1). Consequently, the objects are recognized as if being further away, and thus decrease in the level of detail. This method requires that only a single parameter a be introduced. It is therefore possible to utilize existing programs as much as possible. The processing load from drawing naturally decreases with decreasing level of detail of the models, thereby achieving the intended objective.

Reduce the number of polygons: Render models in multiresolutions in advance. In the power saving mode, render the models as simplified for reduced numbers of polygons. If three-dimensional models are rendered by voxels or primitives, the numbers of these may be reduced. When models are not rendered in multiresolutions, an adaptive meshing technique may be used, in which small polygons or voxels are integrated with adjoining polygons or voxels to generate simplified models so that the simplified models are used subsequently. The same holds for voxels.

Simplify surface rendering: When object surfaces are rendered by such surfaces as a NURBS surface and other free-form surfaces, simplify the rendering. For example, the numbers of control points on those surfaces may be reduced to decrease the parameters. The numbers of patches for dividing the surfaces may be reduced.

Reduce the number of effects: For example, if a scene of an explosion is expressed with a large number of particles, reduce the number of particles. The same holds for metaballs.

Decrease view volume: Put the far plane of the view volume at a distance relatively close to the point of view, thereby reducing the number of objects falling within the drawing space.

Hide objects: For example, create a foggy or nighttime scene or environment in the drawing space. This decreases the number of objects to be drawn, or allows for simple drawing such as monochromatic expression.

Decrease the number of spatial dimensions: Draw the original three-dimensional space into a two-dimensional space. For this purpose, camera parameters such as the point of view may be fixed.

Simplify shading: Apply monochromatic or simple-shaped shading, or remove all shading.

Decrease the screen size: Decrease the size of the image for the display control circuit of the drawing processing unit 26 to display onscreen. This reduces the number of pixels to be processed for display purpose, thereby lowering the processing load. The resolution of the display may be decreased while the screen size is kept unchanged providing an equivalent effect as altering the number of pixels. Incidentally this method may be used with existing programs that do not support the power saving mode. The reason is that what is only required is that at least one of the first main CPU 30, the second main CPU 60, and the MPEG decoder 56 constituting the electronic apparatus 10 be designed to decrease the display resolution in the power saving mode.

While the examples listed above are effected by the cooperation of the first main CPU 30 and the drawing processing unit 26, the second main CPU 60 and the MPEG decoder 56 can also work together to provide the following measures.

Cut off spatial frequency components: When images are coded and decoded in units of spatial frequency components, like JPEG (Joint Photographic Expert Group) still images and MPEG moving images, the subjective qualities of the images are primarily determined by the low frequency components. Thus, the power of the decoder may be lowered by quitting decoding processing at a certain threshold frequency, or displaying only up to frequency components decoded within a relatively short period of time. In this case, the program in operation need not support the power saving mode because it is sufficient that the MPEG decoder 56 recognize and perform the power saving mode.

[1-2] Lower the Level of Temporal Detail Drawn.

The following measures can be taken by the cooperation of the first main CPU 30 and the drawing processing unit 26.

Lower the frame rate: For example, an output of 30 frames/second can be lowered to 15 frames/second to achieve a significant power reduction in the display system. This yields a greater power reduction since processing load in the MPEG decoder 56 is also reduced. According to this measure, the program in operation need not support the power saving mode because it is sufficient that the MPEG decoder 56, the drawing processing unit 26, and the like recognize and perform the power saving mode.

Simplify object motions: Express only the overall movements of objects onscreen while fixing the motions of individual parts of the objects.

Moreover, the following measures can be taken by the cooperation of the second main CPU 60 and the MPEG decoder 56.

Display intra-coded pictures alone: In MPEG, I pictures have no need to refer to other pictures. Drawing I pictures alone frame-by-frame thus makes the drawing processing load lighter. In this case, the program in operation need not support the power saving mode, because it is sufficient that the MPEG decoder 56, the drawing processing unit 26, and the like recognize and perform the power saving mode.

In any of the foregoing cases, the user may be informed of being currently in the power saving mode at any time when entering or during the power saving mode. For that purpose, a system component such as the first main CPU 30 and the second main CPU 60 may be configured to display the notification on the LCD or the like. The same applies to [2] and later.

[2] Reduce the Load of Processing Other than Drawing.

The following measures can be taken by the cooperation of the second main CPU 60 and the MPEG decoder 56.

Simplify the audio processing: As is the case with images described above, quit decoding compressed audio data at an intermediate frequency component. The audio sampling frequency for decoding may also be lowered to thin out data. Stereo sounds may be reproduced as monophonic sounds to reduce the channels to be processed. Audio processing may be quit to stop all audio output. In this case, the program in operation need not support the power saving mode, and it is sufficient that the audio processing unit 58 or the like recognize and perform the power saving mode.

Limit I/O system support: For example, the I/O unit 88, the expansion bus 90, and the security processing unit 92 are limited or stopped being supported If supported, some limitations can be added to further increase the amount of power saved. For example, requests with a large amount of data transmission may be rejected. The intervals of execution of predetermined functions may be increased. The encryption processing unit 94 may simplify such processing as calculations necessary for encryption and decryption. Further to this, if there are communication units (not-shown), the intervals between communication between a plurality of electronic apparatuses 10 may be increased. In any case, the program in operation need not support the power saving mode, because it is sufficient that the second main CPU 60 or the like recognize and perform the power saving mode.

Meanwhile, the following measures can be taken by the cooperation of the first main CPU 30 and the drawing processing unit 26. Here, the game program is considered to be executed by the first main unit 20.

Accelerate the progress of the game: For example, lower the difficulty level of the game so that the user can reach a save point earlier. In skill-oriented games such as Japanese chess and other versus games, the difficulty level can be lowered by such methods such as lowering the skill of the electronic apparatus 10 so that the user can win more easily. In other types of games, the number of opponent characters to defeat may be decreased. The attributes of the characters such as intelligence and life may be lowered to decrease the opponent power. The number of stages to clear may also be reduced.

In the above description, examples of measures intended for the power saving mode have been described. In these examples, the power saving mode is entered depending on the battery level. Low battery level, however, is not of importance when an AC adapter (not-shown) is connected. The shift into the power saving mode may thus be prevented if the AC adapter is present. For that purpose, the monitoring unit 102 may be configured to recognize the presence or absence of an AC adapter by using a known method, and mask the shift instruction if the AC adapter is detected.

Similarly, the monitoring unit 102 may also be configured to permit or inhibit the shift into the power saving mode depending on user settings. Even when the battery level falls, the monitoring unit 102 may mask the shift instruction if the shift into the power saving mode is inhibited by the user.

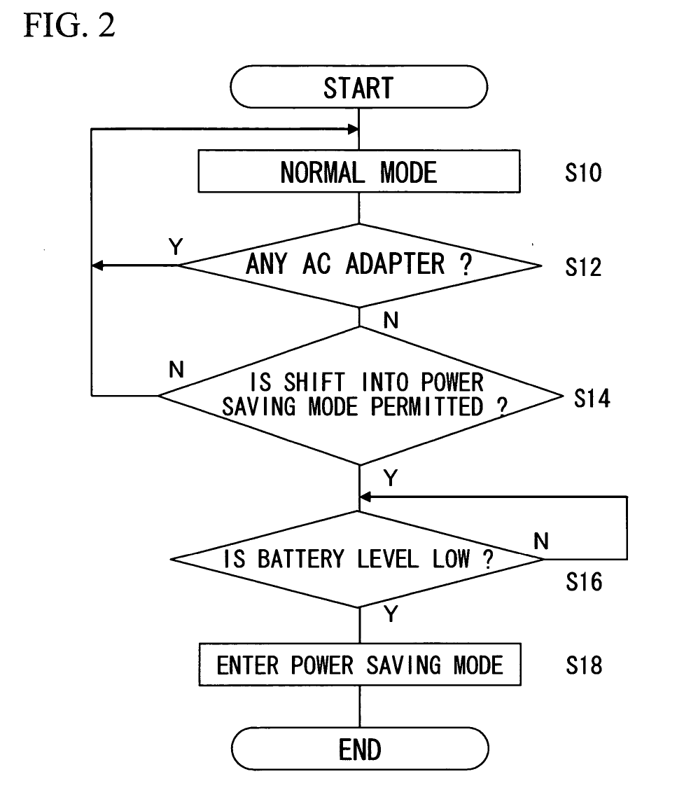

FIG. 2 is a flowchart for showing the mode shift of the electronic apparatus 10 where the foregoing considerations are also taken into account. In an initial state after startup, the electronic apparatus 10 operates in the normal mode (S10). If the electronic apparatus 10 is running on an AC adapter (Y at S12), or if the shift into the power saving mode is inhibited by the user (N at S14), the normal mode is kept unchanged (S10). In the other case (N at S12, Y at S14), the battery level detected by the monitoring unit 102 becomes effective. The monitoring unit 102 continues monitoring while this battery level is higher than a predetermined threshold (N at S16). If the battery level falls to or below the threshold (Y at S16), the monitoring unit 102 issues a shift instruction to enter the power saving mode (S18).

In the above description, the present invention has been described in conjunction with the embodiment thereof. This embodiments has been given solely by way of illustration. It will be understood by those skilled in the art that various modifications may be made thereto, and all such modifications are also intended to fall within the scope of the present invention.

For example, the various types of measures used in the power saving mode, described in the embodiment, may be used in any combination. For instance, the measure for simplifying audio processing may be introduced in combination with the measures for reducing the drawing processing load. In this case, the combined measures are effected by the cooperation of, for example, the first main CPU 30, the second main CPU 60, the drawing processing unit 26, and the MPEG decoder 56.

Along with those measures, typical power management based on a clock control may also be conducted. In that case, the monitoring unit 102 can advantageously be shared between the power management and the mode shift according to the embodiments.

The above embodiments have dealt with two modes, i.e., the normal mode and the power saving mode. Instead, three or more modes may be established to provide one or more intermediate modes between the normal mode and the power saving mode. These intermediate modes may also be regarded as power saving modes.

For example, the normal mode may be used for battery levels of 100% to 70%, a first intermediate mode for 70% to 50%, a second intermediate mode for 50% to 30%, and the final power saving mode for 30% or less. Here, multistep power saving controls may be exercised on a single power saving item, such that LOD is lowered by 30% in the first intermediate mode and by 50% in the second intermediate mode. Moreover, power saving items to be controlled may be increased gradually, such that LOD alone is lowered in the first intermediate mode, surface rendering is simplified additionally in the second intermediate mode, and then audio processing is simplified further in the final power saving mode. In another method, items that are highly effective in saving power may be controlled alternately in succession regardless of the number of corresponding items. For example, it is possible to reduce the level of spatial detail drawn in the first intermediate mode, the level of temporal detail drawn in the second intermediate mode, and the load of processing other than the drawing in the final power saving mode. In any case, which item to control may be selected arbitrarily depending on the intended level of power saving.

While the embodiment has dealt with the case of reducing the processing load in the power saving mode, the contents of the processing need not necessarily be changed for that purpose. For example, the same processing can be performed by switching between different hardware configurations or circuits. Conversely, different hardware components may be used for power saving, thereby realizing processing corresponding to different characteristics and capabilities of the respective hardware components. Even in such a case, the processing load may be considered as being reduced in a broad sense.

While the embodiments have dealt with the case where an explicit notification is provided, notification may instead be achieved by reduction of the processing load itself. For example, when the number of polygons is reduced, it may be reduced more than necessary for saving power so that the user is thus notified of the change in the drawing processing. In that case, the components for reducing the processing load also serve as the notification unit.

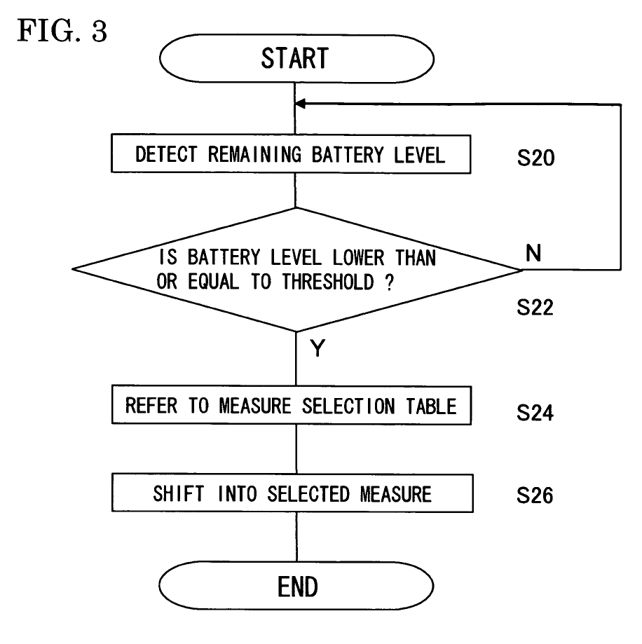

The measure or combination of measures to select to use in the power saving mode described in the embodiment may be determined by the program in operation. FIG. 3 is a flowchart for showing the steps of processing of this program. Initially, the remaining level of the battery 100 is detected via a notification from the monitoring unit 102 or by the program inquiring the remaining level of the battery 100 from the monitoring unit 102 at predetermined time intervals or depending on the development of scenes in the game and the like, for example (S20). If it is detected that the remaining level of the battery 100 falls to or below a predetermined threshold (Y at S22), the program starts determination processing. A plurality of thresholds may be provided so that different measures are selected stepwise corresponding to the respective thresholds. If the remaining level of the battery 100 is not lower than nor equal to the threshold (N at S22), the detection of the remaining level of the battery 100 (S20) is repeated.

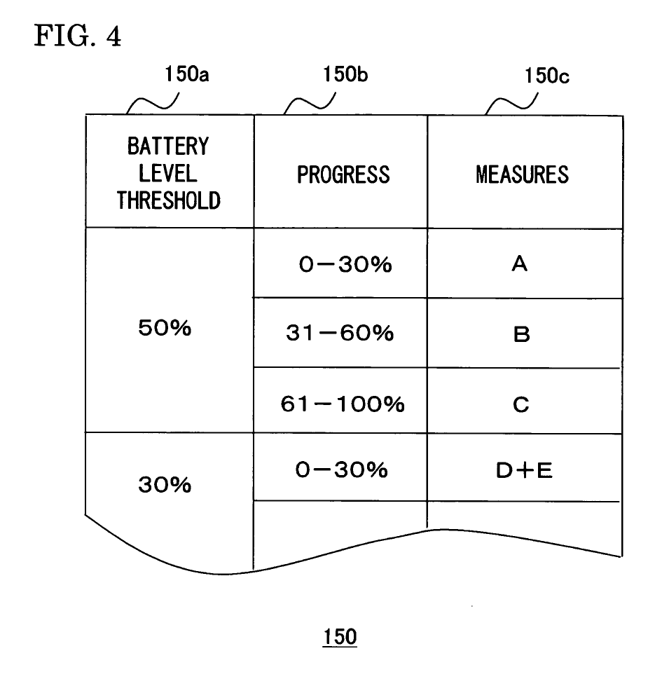

Here, the first main memory 24 contains a measure selection table, for example. The measure selection table shows which measure(s) to select object-by-object depending on the remaining level of the battery 100, the game scene, and the progress of the game such as if a game level is about to be completed. The determination processing module of the program refers to this table (S24), selects a measure(s) for the power saving mode, and communicates with the operating system of the electronic apparatus 10 so that the processing shifts into an execution of the measure(s) (S26). FIG. 4 is a diagram showing an example of the measure selection table. This measure selection table 150 includes a battery level threshold field 150a, a game progress field 150b, and a to-be-selected measure field 150c. For example, when the battery level falls to or below 50% and the game progress is 48%, the determination processing module selects a measure B. The measure selection table 150 is thoughtfully designed so that execution of the power saving mode does not corrupt the game world created by the game creator. Consequently, even when the power saving mode is entered and the image and audio outputs are made simpler than in the normal mode, it is possible to reproduce the game world originally intended by the game creator. It should be noted that, while the measure selection table 150 of FIG. 4 has the game progress field 150b, fields of elements for maintaining the game world, such as a scene field and an object number field, may also be added depending on the contents of the game.

The models to be drawn in the power saving mode need not necessarily be the exact models of the normal mode to which the foregoing measures of the embodiment are applied to lower the drawing qualities and audio-qualities. For example, along with the application of the measures described in the embodiment, some special models that will not appear in the normal mode may be introduced or some appealing scenes and plots may be added within the allowable range of power consumption. That is, a type of hidden mode may be provided aside from the normal game mode. In this case, the program may contain one or more execution modules that have different plots or the like in association with the battery level and other factors. Then, the modules may be called depending on the actual remaining level of the battery 100, and executed by the cooperation of the first main CPU 30 and the drawing processing unit 26. Such measures as hiding of objects described in the embodiment may be combined further. This allows the user to find entertainment both in the normal mode and in the power saving mode separately.

Now, in another aspect of the invention where the I/O system support is limited during the power saving mode, the directions of movement of user-operable objects may be limited. For example, objects that can be moved in eight directions in the normal mode are adjusted such that movement in four directions is allowed. Here, a table showing the relationship between disabled directions of movement and adjoining permitted directions of movement is stored in the second main memory 66 in advance, for example. When a user operates the controls to move the objects in disabled directions, the second main CPU 60 may consult the table, read the corresponding permitted directions of movement, and shift into processing for moving in those directions. As a result, the amount of data to be held and transmitted inside the apparatus, pertaining to the drawing of the motions of the objects, can be reduced to suppressed power consumption.

What is claimed is:

1. An electronic apparatus driven by a battery, comprising:
a control unit which performs predetermined processing to execute a program;
a monitoring unit which detects a remaining level of the battery; and
an adjustment unit which adjusts processing load by changing a graphic processing performed in the control unit, in accordance with the remaining level of the battery detected by the monitoring unit.

2. The electronic apparatus according to claim 1, wherein the adjustment unit reduces the processing load when the remaining level of the battery detected falls below a predetermined threshold.

3. The electronic apparatus according to claim 2, wherein the adjustment unit reduces the load of drawing processing.

4. The electronic apparatus according to claim 3, wherein the adjustment unit lowers the processing load by reducing a level of spatial detail drawn in the drawing processing.

5. The electronic apparatus according to claim 3, wherein the adjustment unit lowers the processing load by reducing a level of temporal detail drawn in the drawing processing.

6. The electronic apparatus according to claim 2, wherein the adjustment unit reduces the processing load by changing a audio processing aside from the drawing processing.

7. The electronic apparatus according to claim 2, further comprising a informing unit which informs user about processing load being reduced when the adjustment unit reduces the processing load.

8. The electronic apparatus according to claim 2, wherein the adjustment unit adjusts so as to accelerate progress of a game when the control unit executes a computer program of the game.

9. A computer program to be executed by a computer provided in an electronic apparatus driven by a battery, the program making the computer exercise the functions of:
detecting a remaining level of the battery of the electronic apparatus; and
adjusting processing load of the electronic apparatus by changing a graphic processing in accordance with the remaining level of the battery detected.

10. The computer program according to claim 9 making the computer exercise the function of adjusting processing load of the electronic apparatus by changing the graphic processing in accordance with a executing status of the computer program, aside from the remaining level of the battery.

11. The computer program according to claim 9 making the computer exercise the function of reducing the processing load when the remaining level of the battery detected falls below a predetermined threshold.

12. A recording medium provided in an electronic apparatus driven by a battery, the recording medium containing a computer program for making a computer exercise the functions of:
detecting a remaining level of the battery of the electronic apparatus; and
adjusting processing load of the electronic apparatus by changing a graphic processing in accordance with the remaining level of the battery detected.

16. A method of controlling an electronic apparatus, the method comprising:
detecting a remaining level of a battery of the electronic apparatus; and
adjusting processing load of the electronic apparatus by changing a graphic processing in accordance with the remaining level of the battery detected.
